(19) United States
(12) Patent Application Publication
(10) Pub. No.: US 2011/0056130 A1
(43) Pub. Date: Mar. 10, 2011

(54) FLOWER POT WITH DOUBLE REVERS

(76) Inventor: Jun WANG, Jiangdu City (CN)

(21) Appl. No.: 12/786,816

(22) Filed: May 25, 2010

(30) Foreign Application Priority Data
Sep. 9, 2009 (CN) 200920231772.0

(51) Int. Cl. A01G 9/02

(52) U.S. Cl. 47/65.5

(57) ABSTRACT

A flower pot with double revers has a pot body, a ring-shaped stepped unit extending outward disposed on the upper part of the pot, and a connecting circle with an “n” shaped cross-section is disposed on the top of the ring-shaped stepped unit. The connecting circle has an inside circle, an outside circle and a top circle, and the top of the inside circle and the top of the outside circle are connected by the top circle. The outside circle and the top of the ring-shaped stepped unit are connected by an inside screw. The inside circle and the outside circle form a connecting circle connected to the top opening of the pot to strengthen the revers of the flower pot.

### FIELD OF THE INVENTION

The present invention relates to the structure of a flower pot.

### BACKGROUND OF THE INVENTION

The conventional flower pot comprises a pot body, and revers are disposed on the top opening of the pot body. This type of flower pot is convenient for users to hold, but it is not confortable and the revers may hurt the users hand. If the pot is heavy or the flower pot material is thin, the revers on the top opening is prone to deformation and splitting, which shortens the service life of the flower pot.

### SUMMARY OF THE INVENTION

The purpose of the present invention is to overcome the disadvantages of the conventional flower pot, to provide a flower pot with double revers that has increased the strength, and to make the revers comfortable to hold so that the pot does not hurt the users hand.

The technical solution applied by the present invention is:

a flower pot with double revers comprises a pot body, a ring-shaped stepped unit extending outward disposed on the upper part of said pot, and a connecting circle with an “n” shaped cross-section is disposed on the top of the ring-shaped stepped unit. The connecting circle comprises an inside circle, an outside circle and a top circle. The top of the inside circle and the top of the outside circle are connected by the top circle. The outside circle and the top of the ring-shaped stepped unit are connected by inside screw.

The present invention has the following advantages: owing to the ring-shaped stepped unit on the upper part of said pot, it is convenient for users to hold the flower pot. The inside circle and the outside circle form a connecting circle connected to the top opening of the pot to strengthen the revers of the flower pot. As a result, the revers can bear more weight and the life of the flower pot is extended.

In order to strengthen the connecting circle, an axial ring-shaped concavity is disposed in said ring-shaped stepped unit, and the lower part of said inside circle is disposed in the axial ring-shaped concavity.

### BRIEF DESCRIPTION OF THE DRAWINGS

FIG. 1 is a structural view of the present invention.

FIG. 2 is another structural view of the present invention.

pot body 1; ring-shaped stepped unit 2; connecting circle 3; outside circle 3-1; inside circle 3-2; top circle 3-3; axial ring-shaped concavity 4.

### DESCRIPTION OF SPECIFIC EMBODIMENTS

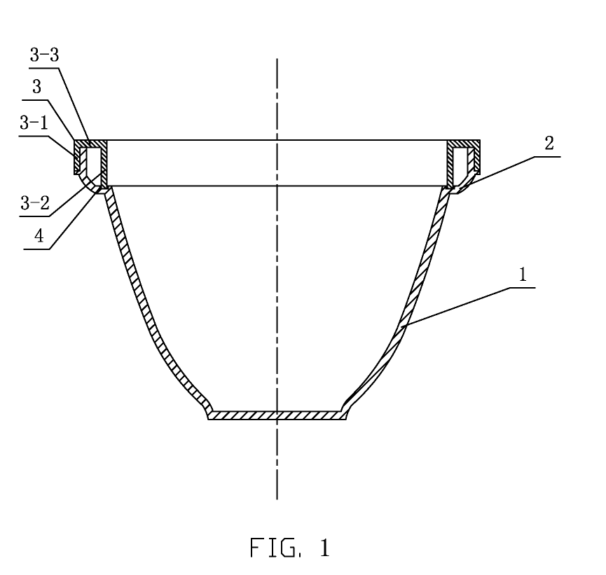

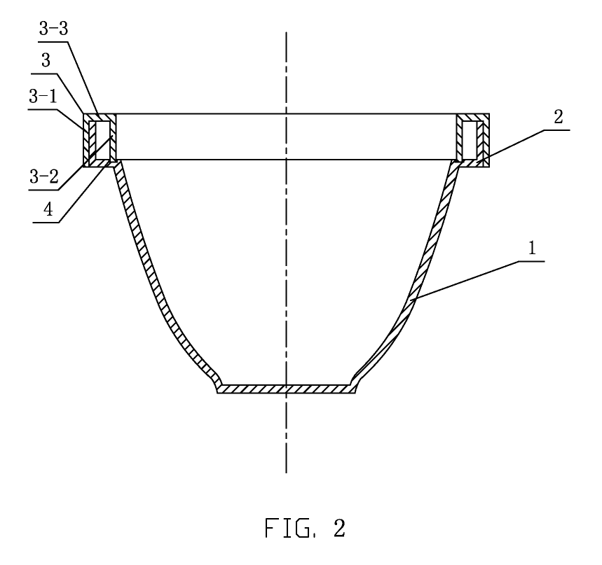

Referring to FIG. 1 and FIG. 2, a flower pot with double revers comprises a pot body 1. A ring-shaped stepped unit 2 extending outward is disposed on the upper part of the pot 1, and a connecting circle 3 whose cross-section is in the shape of “n” is disposed on the top of the ring-shaped stepped unit 2. The connecting circle 3 comprises an inside circle 3-2, an outside circle 3-1 and a top circle 3-3, and the top of the inside circle 3-2 and the top of the outside circle 3-1 are connected by the top circle 3-3. The outside circle 3-1 and the top of the ring-shaped stepped unit 2 are connected by inside screw. An axial ring-shaped concavity 4 is disposed in the ring-shaped stepped unit 2, and the lower part of the inside circle 3-2 is disposed in the axial ring-shaped concavity 4.

What is claimed is:

1. A flower pot with double revers comprises a pot body, wherein a ring-shaped stepped unit extending outward is disposed on the upper part of said pot, and a connecting circle with an “n” shaped cross-section disposed on the top of the ring-shaped stepped unit, and said connecting circle comprises an inside circle, an outside circle and a top circle, and the top of the inside circle and the top of the outside circle are connected by the top circle; and
wherein said outside circle and the top of the ring-shaped stepped unit are connected by an inside screw.

2. The flower pot with double revers according to claim 1, wherein an axial ring-shaped concavity is disposed in said ring-shaped stepped unit, and the lower part of said inside circle is disposed in the axial ring-shaped concavity.
